(19) United States
(12) Patent Application Publication
(10) Pub. No.: US 2008/0123192 A1
(43) Pub. Date: May 29, 2008

(54) Two-in-one light guide means

(76) Inventor: Ching-Bin Lin, Taipei (TW)

Correspondence Address: Ching-Bin Lin, P. O. Box 55-846, Taipei, 104, omitted

(21) Appl. No.: 11/605,174

(22) Filed: Nov. 29, 2006

(51) Int. Cl. G02B 5/02

(52) U.S. Cl. 359/599

(57) ABSTRACT

A light guide device includes a light guide plate; and a reflection member, having reflective diffusing structure formed on the reflection member, and integrally formed in a lower or bottom portion of the light guide plate in order for preventing light loss, for increasing light output efficiency and for lowering production cost.

### BACKGROUND OF THE INVENTION

Back light source may be well provided as a surface light source for liquid crystal display. Such a conventional art may be exemplified by U.S. Pat. No. 5,951,138 (hereinafter called “the prior art”), including a side light type lamp (1), a light guide plate (2) for receiving and guiding light from the lamp (2) upwardly towards a liquid crystal display, a reflector (4) positioned under the light guide plate (2) for reflecting light upwardly into the light guide plate (2), a light diffusion sheet (35) and a prism sheet (30) overlaid on the light guide plate (2) for transmitting light upwardly towards the liquid crystal display.

However, such a prior art has the following drawbacks:
1. Partial light path may be repeatedly reflected or refracted in a gap between the light guide plate (2) and the reflector (4) to easily cause light loss, thereby decreasing the light output efficiency.
2. The reflector is separated from the light guide plate. An assembly job is required to assemble the light guide plate with the reflector, thereby increasing the production procedures and cost for making a back light module.
3. When assembling the reflector with the light guide plate each having large area but thin thickness, the reflector sheet and the light guide plate may be easily warped to cause optical defect such as wet-out.

The present inventor has found the drawbacks of the prior art and invented the present light guide means by integrally combining the light guide plate with the reflector.

### SUMMARY OF THE INVENTION

The object of the present invention is to provide a light guide device including a light guide plate; and a reflection member, having reflective diffusing structure formed on the reflection member, integrally formed in a lower or bottom portion of the light guide plate in order for preventing light loss, and for increasing light output efficiency and lowering production cost.

### BRIEF DESCRIPTION OF THE DRAWINGS

FIG. 1 shows the elements of a back light module in accordance with the present invention.

FIG. 2 is a partially enlarged sectional drawing of the present invention as shown in FIG. 1.

FIG. 3 is a partial sectional drawing of the light guide plate integrally formed with another preferred reflection member in accordance with the present invention.

FIG. 4 shows another preferred embodiment of the present invention.

FIG. 5 shows still another preferred embodiment of the present invention.

FIG. 6 shows further preferred embodiment of the present invention.

FIG. 7 shows still further preferred embodiment of the present invention by integrally forming the reflection member on the bottom of the light guide plate.

### DETAILED DESCRIPTION

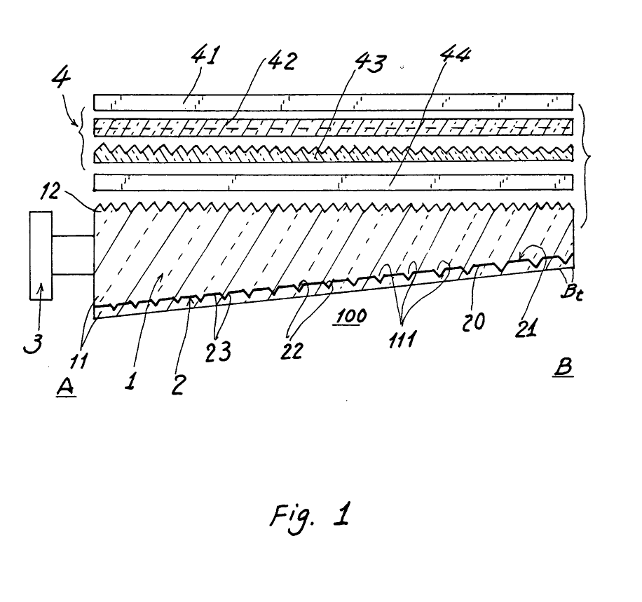

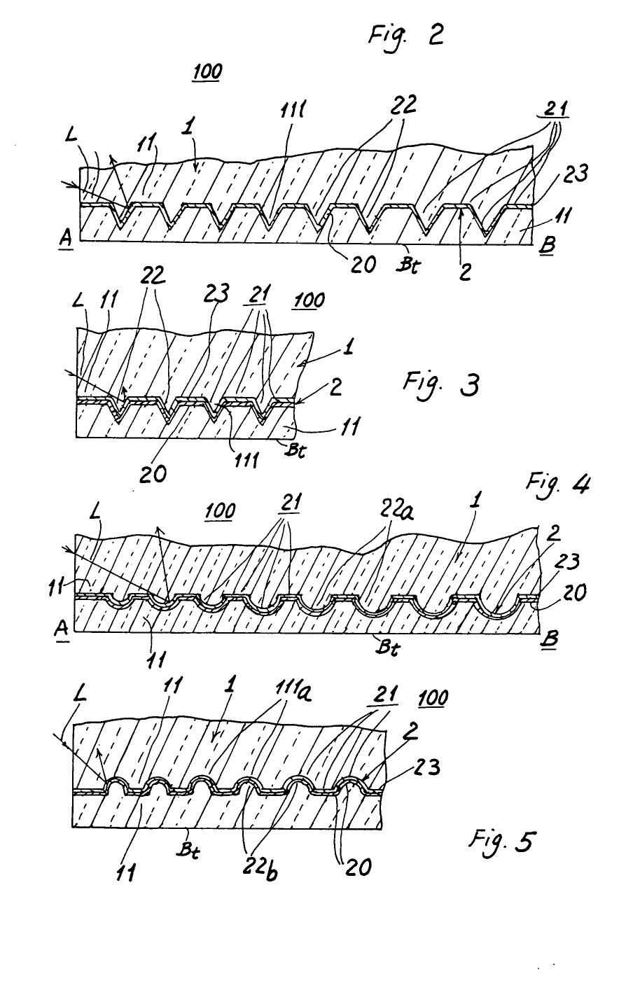

As shown in FIGS. 1 and 2, a back light module is formed by using a light guide means 100 of the present invention.

The back light module includes: a light guide means 100 having a light guide plate 1 integrally formed with a reflection member 2 in a lower or bottom portion of the light guide plate 1; a light source 3 including LED or CCFL formed on a side of the light guide means 100 for projecting light L into the light guide means 100; and a optical film set 4 formed or overlaid on the light guide means 100 for transmitting light from the light guide means 100 upwardly towards an optical display or LCD (not shown) above the optical film set 4 for its illumination.

The optical film set 4 includes: an upper diffusing sheet 41, an upper prism sheet 42 positioned under the upper diffusing sheet 41, a lower prism sheet 43 positioned under and projectively perpendicular to the upper prism sheet 42, and a lower diffusing sheet 44 positioned under the lower prism sheet 43; all sheets superimposed and overlain on the light guide means 100.

The reflection member 2 is integrally formed in a lower portion or bottom portion 11 in the light guide plate 1.

The light guide plate 1 has its upper portion 12 formed as a prism structure or other structural surface for light concentrating or for enhancing other optical properties of the light guide plate and the back light module.

The reflection member 2 may be integrally formed in the lower or bottom portion 11 by the following methods (but not limited in the present invention):
1. The reflection member 2 is integrally formed in the lower portion or bottom portion of the light guide plate 1 by injection molding process.
2. The reflection member 2 is integrally formed in the lower portion or the bottom portion of the light guide plate 1 by chemical bonding, physical bonding, or mechanical locking.
3. The reflection member 2 is embedded, implanted, inserted or buried into the lower or bottom portion of the light guide plate 1 by a plurality of processes, including: extrusion, hot pressing, forming and molding processes.

The reflection member 2 as defined in the present invention may include a reflection plate, a reflection sheet, a reflection film, a reflection layer, etc.

The reflection member 2 includes: a substrate 20 and a reflective diffusing structure 21 formed on the substrate 20.

The reflective diffusing structure 21 includes a plurality of recesses 22 recessed in the substrate 20.

The recess 22 may be formed as a shape selected from the following shapes: a cone, a pyramid, a shuttle-like shape, a semisphere, a dome, an arcuate shape, a semi-cylindrical shape or elongated groove; having a longitudinal section of V shape or other suitable shapes with better optical reflection property, not limited in the present invention.

The substrate 20 may be made of metallic foil (or thin film) having nice optical reflectivity such as silver or aluminum foil (or film). Such a substrate 20 made of metallic foil or film may be directly formed thereon with the reflective diffusing structure 21 (including pattern of recesses 22).

In other words, the substrate 20 may itself form the reflective diffusing structure 21 having a plurality of recesses or V-shaped recesses 22 recessed in the substrate 20 as shown in FIGS. 1 and 2.

The reflective diffusing structure 21 having good light reflectivity may be printed, via transfer printing, on a planar substrate 20 which may be made of metals or polymers.

Or, a metallized planar substrate 20 is printed thereon (via transfer printing) with the reflective diffusing structure 21 having good optical reflectivity. Such a metallized planar substrate 20 is obtained by forming a metallic foil or metal thin film on a polymer substrate via vapor (or vacuum) deposition, sputtering or electroplating processes.

Or, a resin polymer substrate 20 is formed (via hot pressing or other forming methods) with the reflective diffusing structure 21 including the recesses 22 formed therein. The substrate 20 having the recesses 22 formed therein is then plated or coated with a metallic foil or film 23 by vapor (or vacuum) deposition, sputtering or electroplating processes on the reflective diffusing structure 21. Such a reflection member 2 is then integrally formed with (a lower or bottom portion 11 of) the light guide plate 1 to produce the light guide means 100 as shown in FIG. 3.

When forming the reflective diffusing structure 21 on the substrate 20 to be the reflection member 2 of the present invention, the substrate 20 may be pre-formed as a net-like light reflective substrate, including: a net-like knitting sheet; a net-like sheet or film; or a light reflective porous sheet or porous film. Then, the reflection member 2 is integrally formed with the light guide plate 1.

The substrate 20 may be made of resin polymers including: acrylic resin, polyester or polycarbonate. The resin materials may be thermoplastic or thermosetting resins, not limited in the present invention.

As shown in FIG. 4, the afore-mentioned V-shaped recesses 22 have been modified to be recesses 22a each formed as an arcuate shape in the substrate 20.

The incidence light L as emitted from the light source 3 will be reflected upwardly or diffused in multiple directions by the reflection member 2 for enhancing the optical properties of the present invention.

As shown in FIG. 5, each recess 22 or 22a has been modified to be a convex portion 22b protruding upwardly from the substrate 20. Such a convex portion 22b constructs a portion of the reflective diffusing structure 21 on the substrate 20 as illustrated, described and exemplified as aforementioned.

The convex portion 22b may be formed as a shape selected from: a cone, a paramid, a shuttle shape, an arcuate shape, a dome, a cylindrical shape, an elongated convex form or any other shapes, having good light reflectivity.

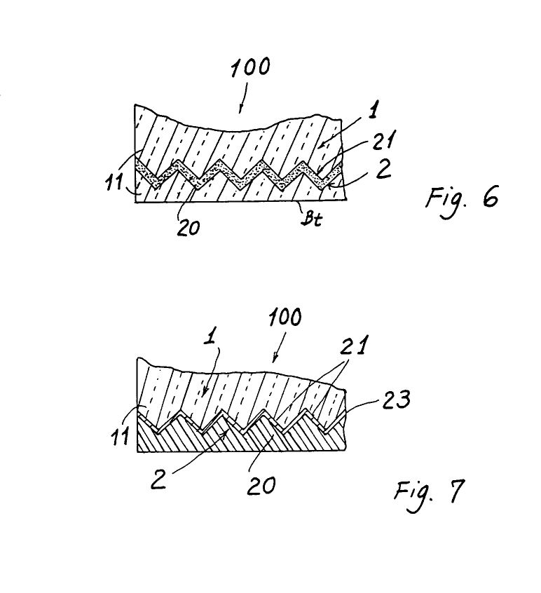

When forming the reflection member 2, a white or milky filler, particles, pigment or dye including titanium dioxide may be added into the resin material; whereby upon blending of the resin material with the white or milky pigment or dye for forming the reflective diffusing structure 21 on the substrate 20 by imprinting, hot pressing (or stamping) or other molding processes, the reflective diffusing structure 21 (having white or milky reflective diffusing surface) will be formed in situ in the reflection member 2, which will then be integrally formed with the light guide plate 1 to obtain the light guide means 100 as shown in FIG. 6.

Naturally, a milky ink may be directly imprinted on the substrate 20 to form the reflective diffusing structure 21 having recesses 22 or convex portions 22b formed on the reflection member 2.

The reflective diffusing structure 21 may also be first formed in a mold by laser, mechanical processing, etching or MEMS. Such a structured mold may then be provided for massively imprinting or forming the reflective diffusing structure (or pattern) 21 onto the metallic substrate 20 for obtaining the reflection member 2.

If the above-mentioned metallic substrate 20 is substituted with a polymer substrate 20, the polymer substrate 20 after being formed with the reflective diffusing structure (or pattern) 21 thereon may be further metallized, such as by plating or coating a metallic film on the reflective diffusing structure 21 by vapor deposition, sputtering or electroplating process.

After forming the reflective diffusing structure 21 on the reflection member 2, the reflection member 2 will then be integrally formed in a lower or bottom portion 11 of the light guide plate 1.

As shown in FIG. 7, the reflection member 2 (including a metallic film 23 plated on the substrate 20) is integrally formed on a lowest or lowermost bottom portion 11 of the light guide plate 1.

The light guide plate 1 may be made of transparent resin materials, including: polycarbonate, polymethyl methacrylate (PMMA), polyethylene terephthalate, and polyethylene glycol terephthalate; but not limited in the present invention.

The V-shaped recess 22 of the reflection member 2 will be engaged with the V-shaped protrusion 111 as downwardly protruding from the light guide plate 1 as shown in FIGS. 1 and 2 to form an interlocking structure between each recess 22 and each protrusion 111 for firmly bonding the reflection member 2 with the light guide plate 1 of the light guide means 100 of the present invention.

In FIG. 5, the convex portion 22b of the reflection member 2 will also be “interlocked” with the recess 111a as recessed in the light guide plate 1, thereby firmly bonding the reflection member 2 in the lower or bottom portion 11 of the light guide plate 1.

The numeral “21” is defined as a “reflective diffusing structure” in the present invention because it has double effects both of light reflection for enhancing brightness; and of light diffusion for enhancing light uniformity.

Each recess 22 or convex portion 22b may be individually formed in or on the substrate 20 to have a longitudinal sectional drawing of V shape, triangular shape, arcuate shape, or semi-circular shape, but not limited in the present invention.

Or, each recess 22 or convex portion 22b may be formed as an elongated shape or linear shape as juxtapositionally formed in or on the substrate 20.

The pitch between the neighboring recesses 22 adjacent to the light source side, side A, may be larger; while the pitch between the neighboring recesses 22 distal from the light source side, side B, may be shorter. The sizes or dimensions of the recesses 22 may be different from one another on the opposite sides (A, B) of the reflection member 2.

The geometric structures or forming methods of the reflection member 2 are not limited in the present invention. For instance, the substrate 20 may itself form the reflective diffusing structure 21 with regular or irregular micro-structural pattern on the substrate 20. The substrate 20 may be a flat or planar substrate, upon which the reflective diffusing structure 21 is formed, imprinted, molded or processed, thereby producing the light guide means 100 of the present invention.

If the reflection member 2 is not formed on a lowest bottom of the light guide plate 1 (as shown in FIG. 7), there is a “bottom layer” between the lowest bottom Bt of the light guide plate 1 and the reflection member 2 as shown in FIGS. 1-6. In other words, the reflection member 2 is “sandwiched” in between an upper major portion of the light guide plate 1 and a bottom (or lower) layer adjacent to the lowest bottom Bt of the light guide plate 1. Such a bottom layer (between Bt and the reflection member 2) may have a thickness ranging from 50 μm through 500 μm, but not limited in the present invention.

The present invention is superior to the prior art with the following advantages:
1. The light guide plate 1 and the reflection member 2 are integrally formed to eliminate any gap or void space between a light guide plate and a reflector for preventing unexpected repeated reflection or refraction in the gap, thereby reducing light loss and enhancing light output efficiency for saving energy and cost.
2. The light guide plate 1 and the reflection member 2 are integrally formed to obtain a light guide means 100 which is a compact unit. The assembly procedures for assembling the two elements 1, 2 will be saved, thereby reducing the production cost.
3. The light guide plate 1 has its bottom protrusions 111 engaged with the recesses 22 of the reflection member 2 to form an interlocking mechanism between the light guide plate 1 and the reflection member 2, thereby enhancing the structural stability of the light guide means 100 for preventing from being warped and preventing optical defects such as wet-out. Both optical property and mechanical strength will then be greatly enhanced.
4. The structural patterns of the reflective diffusing structure 21 of the reflection member 2 have been firmly bonded in the interior of the light guide plate 1 so as to prevent “peeling” or breakage of ink, metallic film, printing layer, coating layer or plating layer of the reflective diffusing structure 21 from the substrate 20, thereby ensuring a reliable quality and commercial value of the light guide means 100.

The present invention may be modified without departing from the spirit and scope of the present invention.

1. A light guide means comprising:
a light guide plate made of transparent materials; and
a reflection member having a reflective diffusing structure formed on said reflection member and integrally formed in said light guide plate; said reflection member sandwiched in between an upper major portion of the light guide plate and a bottom layer adjacent to a lowest bottom of the light guide plate, whereby upon projection of incidence light into said light guide plate from a side type light source, the light will be reflected and diffused by said reflection member into said light guide plate for enhancing brightness and light uniformity of said light guide means;
said reflective diffusing structure including a plurality of recesses recessed in said reflection member to be engaged and interlocked with a plurality of protrusions protruding downwardly from said light guide plate for firmly bonding said reflection member in said light guide plate.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)
